(19) United States
(12) Patent Application Publication
(10) Pub. No.: US 2015/0325177 A1
(43) Pub. Date: Nov. 12, 2015

(54) IMAGE DISPLAY APPARATUS AND CONTROL METHOD THEREOF

(71) Applicant: CANON KABUSHIKI KAISHA, Tokyo (JP)

(72) Inventor: Ikuo Takanashi, Fujisawa-shi (JP)

(21) Appl. No.: 14/707,406

(22) Filed: May 8, 2015

(30) Foreign Application Priority Data
May 12, 2014 (JP) 2014-098491
Mar. 6, 2015 (JP) 2015-044408

(51) Int. Cl. G09G 3/34

(52) U.S. Cl. CPC G09G 3/3406; G09G 2360/141

(57) ABSTRACT

A image display apparatus according to the present invention includes: a light emitting unit; a display unit configured to display an image on a screen by modulating light emitted from the light emitting unit; a control unit configured to control light emission by the light emitting unit on the basis of input image data; an acquisition unit configured to acquire a measurement value of light emitted from the screen; and a first correcting unit configured to correct a current measurement value acquired by the acquisition unit on the basis of a reference condition, which is a reference emission condition of the light emitting unit, and a current emission condition of the light emitting unit.

### BACKGROUND OF THE INVENTION

1. Field of the Invention

The present invention relates to an image display apparatus and a control method thereof.

2. Description of the Related Art

Recent advancements in the image quality of image display apparatuses have been accompanied by rising demand among users for improved stability and color reproducibility in the image display apparatuses. Moreover, nowadays image data obtained by digitizing medical images such as X-ray images are used in medical settings, and diagnoses are performed using medical images displayed on a screen. Poor stability and color reproducibility in the image display apparatus during this type of diagnosis may lead to a misdiagnosis. Therefore, when a medical image is displayed on the screen, a particularly high level of performance is required of the image display apparatus in terms of the stability and color reproducibility.

However, the color reproducibility of an image display apparatus varies due to deterioration over time of a display element and so on. To realize stable color reproducibility at all times, therefore, it is necessary to calibrate the brightness and the color of the screen periodically. In a calibration, for example, image processing parameters used during image processing implemented on input image data (image data input into the image display apparatus) are adjusted so that a gamma characteristic of the image display apparatus approaches a desired characteristic.

Japanese Patent Application Publication No. 2005-208548, for example, discloses a conventional technique relating to calibration.

In the technique disclosed in Japanese Patent Application Publication No. 2005-208548, when a measurement value of an optical sensor that measures light emitted from a screen varies from a target value, a calibration is executed to bring the measurement value of the optical sensor closer to the target value.

Further, a technique of using a light emission unit (a backlight) having a plurality of light sources and controlling emission brightness (emitted light amounts) of the plurality of light sources individually in accordance with a statistic of the input image data has been proposed as a conventional technique relating to a liquid crystal display apparatus (Japanese Patent Application Publication No. 2006-30588). By performing this control, a contrast of a display image (an image displayed on the screen) can be improved. This type of control (control for partially modifying the emission brightness of the backlight) is known as “local dimming control”.

As described above, a measurement value from an optical sensor is normally used in a calibration, a determination as to whether or not to execute the calibration, and so on.

However, when the emission brightness of the light source varies in response to variation in the input image data while local dimming control is underway, the measurement value of the optical sensor may vary. Therefore, variation in the measurement value due to temporal deterioration of the display element or the like cannot be detected with a high degree of precision while local dimming control is underway, and as a result, it may be impossible to execute the calibration, the determination as to whether or not to execute the calibration, and so on with a high degree of precision.

Japanese Patent Application Publication No. 2013-68810, for example, discloses a conventional technique for solving this problem. In the technique disclosed in Japanese Patent Application Publication No. 2013-68810, variation in the emission brightness of light sources provided on the periphery of a measurement position of an optical sensor due to local dimming control is suppressed during a calibration. When the technique disclosed in Japanese Patent Application Publication No. 2013-68810 is used, variation in the measurement value of the optical sensor due to the local dimming control can be suppressed.

In the technique disclosed in Japanese Patent Application Publication No. 2013-68810, however, when a suppression region is large, an obtained display image differs greatly in appearance from a display image obtained when variation in the emission brightness due to local dimming control is not suppressed. The suppression region is a region in which variation in the emission brightness due to local dimming control is suppressed. For example, the manner in which black dries down and the contrast of the obtained display image differ greatly from a display image obtained when variation in the emission brightness due to local dimming control is not suppressed. This variation in the appearance of the display image is caused by a reduction in a contrast improvement effect due to local dimming in the suppression region.

Furthermore, in the technique disclosed in Japanese Patent Application Publication No. 2013-68810, variation due to local dimming control in the emission brightness of light sources provided in regions outside the region on the periphery of the measurement position of the optical sensor is not suppressed, and the light emitted from these light sources is diffused normally. Therefore, with the technique disclosed in Japanese Patent Application Publication No. 2013-68810, when the suppression region is small, the emission brightness of the light sources in other regions varies in response to the local dimming control, and as a result, the measurement value of the optical sensor may vary greatly. Hence, it may be impossible to execute the calibration and the determination as to whether or not to execute the calibration with a high degree of precision.

Note that the problem described above (variation in the measurement value of the optical sensor due to variation in the emission condition of the light emission unit in response to variation in the input image data) is not limited to cases in which local dimming control is performed, and occurs likewise when light emission from the light emission unit is controlled on the basis of the input image data.

### SUMMARY OF THE INVENTION

The present invention provides a technique with which a measurement value of an optical sensor can be estimated independently of variation in an emission condition of a light emission unit due to variation in input image data without causing a display image to vary in appearance, even while local dimming control is underway.

The present invention in its first aspect provides an image display apparatus comprising:

a light emitting unit;

a display unit configured to display an image on a screen by modulating light emitted from the light emitting unit;

a control unit configured to control light emission by the light emitting unit on the basis of input image data;

an acquisition unit configured to acquire a measurement value of light emitted from the screen; and

a first correcting unit configured to correct a current measurement value acquired by the acquisition unit on the basis of a reference condition, which is a reference emission condition of the light emitting unit, and a current emission condition of the light emitting unit.

The present invention in its second aspect provides a control method for an image display apparatus having a light emitting unit and a display unit configured to display an image on a screen by modulating light emitted from the light emitting unit,

the control method comprising:

a control step of controlling light emission by the light emitting unit on the basis of input image data;

an acquisition step of acquiring a measurement value of light emitted from the screen; and

a first correction step of correcting a current measurement value acquired in the acquisition step on the basis of a reference condition, which is a reference emission condition of the light emitting unit, and a current emission condition of the light emitting unit.

The present invention in its third aspect provides a non-transitory computer readable medium that stores a program, wherein the program causes a computer to execute the method.

According to the present invention, a measurement value of an optical sensor can be estimated independently of variation in an emission condition of a light emission unit due to variation in input image data without causing a display image to vary in appearance, even while local dimming control is underway. As a result, a calibration and a determination as to whether or not to execute the calibration can be performed with a high degree of precision.

Further features of the present invention will become apparent from the following de script ion of exemplary embodiments with reference to the attached drawings.

### BRIEF DESCRIPTION OF THE DRAWINGS

FIG. 1 is a block diagram showing an example of a functional configuration of an image display apparatus according to a first embodiment;

FIG. 2 is a view showing an example of a positional relationship between an optical sensor and a display unit according to the first embodiment;

FIG. 3 is a flowchart showing an example of an operation of the image display apparatus according to the first embodiment;

FIG. 4 is a flowchart showing an example of an operation of the image display apparatus according to the first embodiment;

FIG. 5 is a view showing an example of an input image according to the first embodiment;

FIG. 6 is a view showing an example of a synthesized image according to the first embodiment;

FIG. 7 is a view showing an example of an OSD image according to the first embodiment;

FIG. 8 is a block diagram showing an example of a functional configuration of an image display apparatus according to a second embodiment;

FIG. 9 is a flowchart showing an example of an operation of the image display apparatus according to the second embodiment;

FIG. 10 is a flowchart showing an example of an operation of the image display apparatus according to the second embodiment;

FIG. 11 is a view showing an example of a measurement image according to the second embodiment; and

FIG. 12 is a view showing an example of a synthesized image according to the second embodiment.

### DESCRIPTION OF THE EMBODIMENTS

### First Embodiment

An image display apparatus and a control method thereof according to a first embodiment of the present invention will be described below with reference to the drawings.

Note that in this embodiment, an example of a case in which the image display apparatus is a transmission type liquid crystal display apparatus will be described, but the image display apparatus is not limited to a transmission type liquid crystal display apparatus, and may be any image display apparatus having an independent light source. For example, the image display apparatus may be a reflection type liquid crystal display apparatus. Alternatively, the image display apparatus may be a micro electro mechanical system (MEMS) shutter type display that uses a MEMS shutter instead of a liquid crystal element.

(Configuration of Image Display Apparatus)

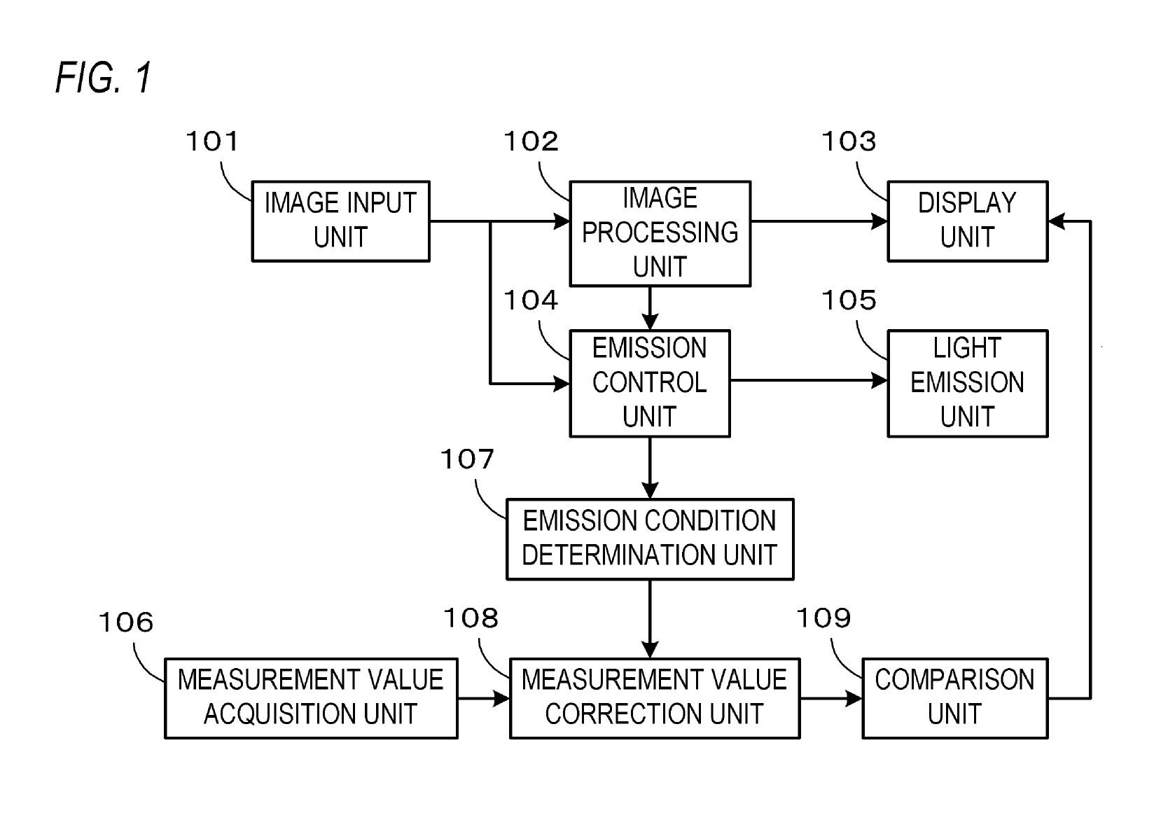

FIG. 1 is a block diagram showing an example of a functional configuration of the image display apparatus according to this embodiment. As shown in FIG. 1, the image display apparatus according to this embodiment includes an image input unit 101, an image processing unit 102, a display unit 103, an emission control unit 104, a light emission unit 105, a measurement value acquisition unit 106, an emission condition determination unit 107, a measurement value correction unit 108, a comparison unit 109, and so on.

The image input unit 101 is an image data input terminal, for example. An input terminal compatible with a standard such as High-Definition Multimedia Interface (HDMI), Digital Visual Interface (DVI), or Display Port may be used as the image input unit 101. The image input unit 101 is connected to an image output apparatus such as a personal computer or a video player. The image input unit 101 acquires (receives) image data output from the image output apparatus, and outputs the acquired image data (input image data) to the image processing unit 102 and the emission control unit 104.

The image processing unit 102 generates synthesized image data by synthesizing measurement image data with the input image data output from the image input unit 101, and generates display image data by implementing image processing on the synthesized image data. The image processing unit 102 then outputs the generated display image data to the display unit 103.

The measurement image data are image data representing a measurement image. By synthesizing the measurement image data with the input image data, image data representing a synthesized image in which the measurement image is superimposed on the input image represented by the input image data are generated as the synthesized image data.

Note that the measurement image data may be prepared in advance or generated by the image processing unit 102. For example, pixel values of the measurement image data may be determined in advance, and the measurement image data may be generated on the basis of the pixel values. Alternatively, the pixel values of the measurement image data may be input by a user.

The processing for generating the synthesized image data may be omitted. For example, the display image data may be generated by implementing image processing on the input image data. In this case, image data representing an image on which the measurement image is superimposed may be acquired as the input image data, or image data representing an image on which the measurement image is not superimposed may be acquired as the input image data.

The processing for generating the synthesized image data may be executed only when light (screen light) emitted from a screen is to be measured. For example, when the screen light is to be measured, the display image data may be generated by implementing image processing on the synthesized image data, and when the screen light is not to be measured, the display image data may be generated by implementing image processing on the input image data.

The image processing executed by the image processing unit 102 includes brightness correction processing, color correction processing, and so on, for example. By implementing the image processing on the image data (the input image data or the synthesized image data), the brightness and color of the screen when an image based on the image data is displayed on the screen are modified (corrected). The image processing unit 102 implements the image processing on the image data using image processing parameters. Initial values of the image processing parameters are determined in advance, for example. The image processing parameters are then adjusted by calibrating at least one of the brightness and the color of the screen. The image processing parameters include an R gain value, a G gain value, a B gain value, and so on, for example. The R gain value is a gain value that is multiplied by an R value (a red color component value) of the image data, the G gain value is a gain value that is multiplied by a G value (a green color component value) of the image data, and the B gain value is a gain value that is multiplied by a B value (a blue color component value) of the image data. The image processing unit 102 generates the display image data by multiplying the R gain value by the R value of the image data (the input image data or the synthesized image data), multiplying the G gain value by the G value of the image data, and multiplying the B gain value by the B value of the image data.

Note that the calibration for determining the image processing parameters may be performed by either the image display apparatus or a different apparatus to the image display apparatus.

In this embodiment, an example of a case in which the pixel values of the image data are RGB values will be described, but the pixel values of the image data are not limited thereto, and may be YCbCr values or the like, for example.

The image processing parameters are not limited to the R gain value, G gain value, and B gain value. Moreover, the image processing is not limited to the processing described above. For example, the image processing parameters may include a pixel value conversion look up table (LUT), and the image processing may include processing for converting the pixel values of the image data using the pixel value conversion LUT. The pixel value conversion LUT is constituted by table data expressing correspondence relationships between pre-conversion pixel values and post-conversion pixel values of the image data. A pixel value conversion function expressing the correspondence relationships between the pre-conversion pixel values and the post-conversion pixel values may be used instead of the pixel value conversion LUT. Furthermore, the image processing parameters may include addition values that are added to the pixel values, and the image processing may include processing for adding the addition values to the pixel values of the image data.

The display unit 103 displays an image on the screen by modulating light emitted from the light emission unit 105. In this embodiment, the display unit 103 is a liquid crystal panel having a plurality of liquid crystal elements. A transmittance of each liquid crystal element is controlled in accordance with the display image data output from the image processing unit 102. The light emitted from the light emission unit 105 is transmitted through the respective liquid crystal elements at a transmittance corresponding to the display image data, and as a result, an image is displayed on the screen.

The emission control unit 104 controls light emission (an emission brightness, an emission color, and so on) by the light emission unit 105 on the basis of the input image data output from the image input unit 101. In this embodiment, the emission control unit 104 determines an emission control value on the basis of the input image data. The determined emission control value is then set in (output to) the light emission unit 105 by the emission control unit 104. In other words, in this embodiment, the emission control value set in the light emission unit 105 is controlled on the basis of the input image data. The emission control value is a target value of the emission brightness, emission color, or the like of the light emission unit 105. For example, the emission control value is a pulse width or a pulse amplitude of a pulse signal which is a drive signal that is applied to the light emission unit 105. In a case where the emission brightness of the light emission unit 105 is subjected to Pulse width modulation (PWM) control, the pulse width of the drive signal may be determined as the emission control value. In a case where the emission brightness of the light emission unit 105 is subjected to Pulse amplitude modulation (PAM) control, the pulse amplitude of the drive signal may be determined as the emission control value. In a case where the emission brightness of the light emission unit 105 is subjected to Pulse harmonic modulation (PHM) control, both the pulse width and the pulse amplitude of the drive signal may be determined as the emission control value.

In this embodiment, the light emission unit 105 includes a plurality of light sources (light emission blocks) that can be subjected to light emission control individually. The emission control unit 104 controls light emission by the respective light sources on the basis of image data (all or a part of the input image data) to be displayed in regions of the screen corresponding respectively to the plurality of light sources (local dimming control). More specifically, a light source is provided in each of a plurality of divided regions constituting a region of the screen. The emission control unit 104 acquires a characteristic amount (a statistic) of the input image data in each divided region. The emission control unit 104 then determines, for each divided region, the emission control value of the light source provided in the divided region on the basis of the characteristic amount acquired in relation to the divided region. The characteristic amount is a histogram or a representative value of the pixel values, a histogram or a representative value of the brightness value, a histogram or a representative value of a chromaticity, or the like, for example. The representative value is a maximum value, a minimum value, an average value, a mode value, an intermediate value, or the like, for example. The emission control unit 104 outputs the determined emission control values to the light emission unit 105.

By increasing the emission brightness of the light sources in regions where the input image data are light and reducing the emission brightness of the light sources in regions where the input image data are dark, a contrast of the display image (the image displayed on the screen) can be increased. For example, by determining the emission control values such that the emission brightness increases steadily as the brightness expressed by the characteristic amount increases, the contrast of the display image can be increased.

When the light source emission color is controlled to conform to the color of the input image data, it is possible to enlarge a color gamut or enhance chroma of the display image.

Note that the region corresponding to the light source is not limited to the divided region described above, and a region that overlaps a region corresponding to another light source or a region that is not adjacent to a region corresponding to another light source may be set as the region corresponding to the light source. For example, the region corresponding to the light source may be a region having a larger or smaller size than the divided region.

Further, in this embodiment, a plurality of different regions are set as the plurality of regions corresponding to the plurality of light sources, but the present invention is not limited thereto, and an identical region to a region corresponding to another light source, for example, may be set as the region corresponding to the light source.

The light emission unit 105 functions as a surface-shaped light-emitting body that irradiates aback surface of the display unit 103 with light (white light, for example). The light emission unit 105 emits light in accordance with the set emission control values.

As described above, the light emission unit 105 includes the plurality of light sources that can be subjected to light emission control individually. Each light source includes at least one light-emitting element. A light-emitting diode (LED), an organic electro-luminescence (EL) element, a cold-cathode tube element, or the like, for example, may be used as the light-emitting element. Each light source emits light in accordance with the emission control value determined in relation to the light source. The emission brightness of the light source increases in response to an increase in the pulse width and pulse amplitude of the drive signal. In other words, the emission brightness of the light source decreases in response to a reduction in the pulse width and pulse amplitude of the drive signal. When the light source includes a plurality of light emitting elements having different emission colors, the emission color of the light source can be controlled in addition to the emission brightness of the light source. More specifically, the emission color of the light source can be modified by modifying an emission brightness ratio among the plurality of light emitting elements provided in the light source.

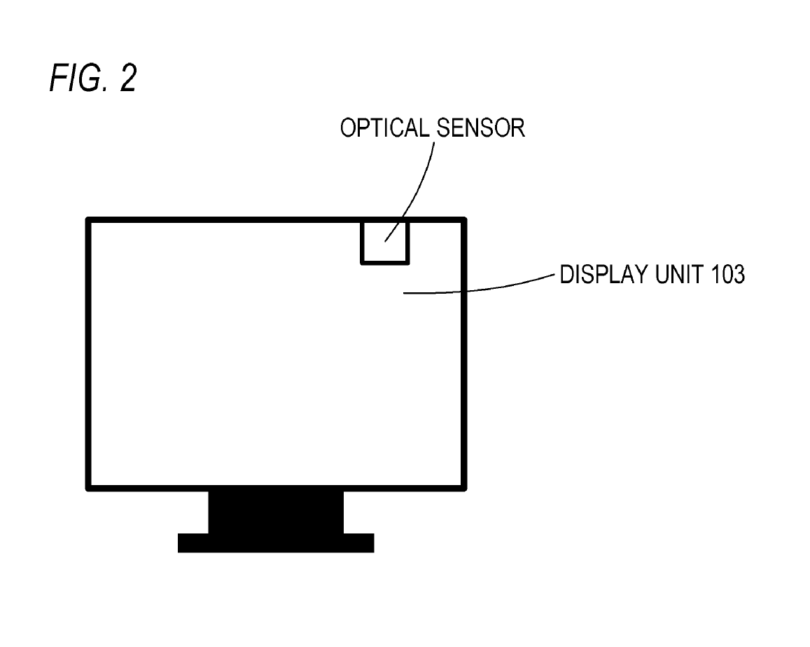

The measurement value acquisition unit 106 acquires a measurement value of the light emitted from the screen. In this embodiment, the measurement value acquisition unit 106 acquires a measurement value of the light emitted from a region of the screen in which the measurement image is displayed. For example, the measurement value acquisition unit 106 includes an optical sensor that measures the screen light, and acquires a measurement value of the screen light from the optical sensor. A brightness sensor, a chromaticity sensor, an image capturing apparatus, or the like may be used as the optical sensor. FIG. 2 shows an example of a positional relationship between the optical sensor and the display unit 103 (the screen). FIG. 2 is a front view showing the image display apparatus from a front surface side. In FIG. 2, the optical sensor is provided on an upper end of the screen, and a detection surface (a measurement surface) of the optical sensor is disposed in the direction of the screen in order to measure light emitted from a partial region (a predetermined measurement region) of the screen. In the example of FIG. 2, the optical sensor is provided such that the measurement surface opposes the measurement region. The measurement image is displayed in the measurement region, and the optical sensor measures a display color and a display brightness of the measurement image. The measurement value acquisition unit 106 outputs the measurement value acquired from the optical sensor to the measurement value correction unit 108. The measurement value is constituted by XYZ tri-stimulus values, for example.

Note that another value may be used as the measurement value of the screen light. For example, the measurement value may be an instantaneous value of the screen light, a time-averaged value of the screen light, or a time-integrated value of the screen light. The measurement value acquisition unit 106 may acquire the instantaneous value of the screen light from the optical sensor, and calculate the time-averaged value or the time-integrated value of the screen light as the measurement value from the instantaneous value of the screen light. When the instantaneous value of the screen light is likely to be affected by noise, for example when the screen light is dark, a measurement period of the screen light is preferably extended, whereupon the time-averaged value or the time-integrated value of the screen light is acquired as the measurement value. In so doing, a measurement value that is less affected by noise can be acquired. Furthermore, the measurement value may be a brightness value, a chromaticity value, an RGB value, or the like instead of an XYZ value.

The optical sensor may be a separate apparatus to the image display apparatus 100.

The region in which the screen light is measured does not have to be a predetermined region. For example, the measurement region may be a region that can be modified by the user.

The emission condition determination unit 107 acquires the emission control values output from the emission control unit 104 (the emission control values set in the light emission unit 105), and determines the emission condition of the light emission unit 105 on the basis of the emission control values set in the light emission unit 105. The emission condition determination unit 107 then outputs an emission condition value representing a determination result relating to the emission condition of the light emission unit 105 to the measurement value correction unit 108.

In this embodiment, the emission condition determination unit 107 determines the emission condition of the light emission unit 105 in the region where the measurement image is displayed (the predetermined measurement region). More specifically, the emission condition determination unit 107 acquires the brightness of the light emitted by the light emission unit 105 onto the measurement region (a region on the back surface of the display unit 103 corresponding to the measurement region) on the basis of the emission control values of the respective light sources. The emission condition determination unit 107 then outputs an emission condition value representing the brightness of the light emitted by the light emission unit 105 onto the measurement region to the measurement value correction unit 108.

Note that the emission color of the light emission unit 105 may be determined as the emission condition instead of the emission brightness of the light emission unit 105. Further, both the emission brightness and the emission color of the light emission unit 105 may be determined as the emission condition.

The light from the light sources is diffused, and therefore the measurement region is irradiated not only with light from the light source positioned within the measurement region, but also light (diffused light; leaked light) from a light source positioned outside the measurement region. In other words, the brightness of the light emitted onto the measurement region by the light emission unit 105 is a brightness of synthesized light combining light from a plurality of light sources.

The emission condition determination unit 107 acquires an emission brightness corresponding to the emission control value of the light source positioned within the measurement region as the brightness of the light emitted onto the measurement region from this light source. The emission brightness corresponding to the emission control value can be determined using a function or a table expressing a correspondence relationship between the emission control value and the emission brightness. Alternatively, when the emission brightness corresponding to the emission control value is proportionate to the emission control value, the emission control value may be used as the emission brightness corresponding to the emission control value.

Further, the emission condition determination unit 107 acquires a value obtained by multiplying a coefficient by the emission brightness corresponding to the emission control value of a light source positioned outside the measurement region as the brightness of the light emitted onto the measurement region from this light source.

The emission condition determination unit 107 then calculates a sum of the acquired brightness values of the respective light sources as the brightness of the light emitted by the light emission unit 105 onto the measurement region.

In this embodiment, a diffusion profile expressing the coefficient to be multiplied by the emission brightness is prepared in advance for each light source. The emission condition determination unit 107 reads the coefficient from the diffusion profile, and calculates the brightness of the light emitted onto the measurement region from the light source by multiplying the read coefficient by the emission brightness corresponding to the emission control value. The coefficient is an arrival rate at which the light emitted from the light source reaches the measurement region. More specifically, the coefficient is a brightness ratio of the light emitted from the light source, i.e. a ratio of the brightness in the position of the measurement region relative to the brightness in the position of the light source. The brightness of the light that reaches the measurement region after being emitted from the light source decreases by a steadily smaller amount as a distance between the light source and the measurement region shortens. On the diffusion profile, therefore, the coefficient is set to be steadily larger (closer to 1) as the distance between the light source and the measurement region decreases. In other words, the brightness of the light that reaches the measurement region after being emitted from the light source decreases by a steadily larger amount as the distance between the light source and the measurement region lengthens, and therefore, on the diffusion profile, the coefficient is set to be steadily smaller (closer to 0) as the distance between the light source and the measurement region increases. In this embodiment, 1 is set as the coefficient corresponding to the light source in the measurement region, and a smaller value than 1 is set as the coefficient corresponding to the light source outside the measurement region.

The emission condition of the light emission unit 105 in the measurement region may be acquired using the emission control values of all of the light sources or the emission control values of apart of the light sources. For example, the emission condition may be acquired using the emission control value of the light source in the measurement region and the emission control values of light sources removed from the measurement region by a distance no greater than a threshold. The threshold that is compared to the distance from the measurement region may be a fixed value determined in advance by a manufacturer, or a value that can be modified by the user. The emission brightness corresponding to the emission control value of a light source positioned directly below the measurement region (for example, the light source that is closest to the center of the measurement region) may be acquired as the emission condition. The emission brightness corresponding to the emission control value of the light source positioned directly below the measurement region is preferably acquired as the emission condition particularly in a case where diffusion of the light from the light sources is small. In a case where diffusion of the light from the light sources is small, an emission condition having a small error can be acquired even when the emission brightness corresponding to the emission control value of the light source positioned directly below the measurement region is acquired as the emission condition. Moreover, by omitting from consideration the light sources other than the light source positioned directly below the measurement region, a processing load can be lightened.

The measurement value correction unit 108 acquires the emission condition value expressing the current emission condition of the light emission unit 105 from the emission condition determination unit 107, and acquires the current measurement value acquired by the measurement value acquisition unit 106. The measurement value correction unit 108 then corrects the current measurement value of the screen light on the basis of a reference condition value and the current emission condition value (first correction processing). The reference condition value is a value expressing a reference condition which is a reference emission condition of the light emission unit 105. After correcting the measurement value, the measurement value correction unit 108 outputs a corrected measurement value to the comparison unit 109.

The measurement value of the screen light varies in response to variation in the emission condition of the light emission unit 105 even when the pixel values of the image data in the measurement region remain constant. For example, even when the pixel values of the image data in the measurement region are constant, the measurement value of the screen light varies in response to variation in the emission conditions of the light sources in the measurement region and regions on the periphery thereof. Therefore, when the measurement value of the screen light is used as is, a calibration and a determination as to whether or not to execute the calibration cannot be performed with a high degree of precision.

Hence, in this embodiment, the measurement value correction unit 108 corrects the current measurement value of the screen light on the basis of the reference condition value and the current emission condition value. More specifically, a current measurement value of the screen light when the emission condition of the light emission unit 105 is controlled to the reference condition is estimated on the basis of the reference condition value, the current emission condition value acquired by the emission condition determination unit 107, and the current measurement value acquired by the measurement value acquisition unit 106. In so doing, a value that is not dependent on variation in the measurement value of the screen light caused by variation in the emission condition of the light emission unit 105 from the reference condition, or in other words a value that is not dependent on variation in the emission condition of the light emission unit 105, can be acquired as the corrected measurement value.

The comparison unit 109 compares the corrected measurement value with a first target value. When a difference between the corrected measurement value and the first target value equals or exceeds a threshold, the user is notified that the corrected measurement value differs from the first target value. By issuing this notification, the user can be prompted to execute a calibration at an appropriate timing. In this embodiment, the comparison unit 109 generates notification image data representing an on-screen display (OSD) image on which a message indicating that the measurement value of the screen light differs from the target value is written, and outputs the notification image data to the display unit 103. As a result, the OSD image (a notification image) is displayed on the screen so that the user can be informed that the measurement value of the screen light differs from the target value.

Note that the method of notifying the user is not limited to the method described above. For example, the user may be notified by displaying a graphic image (an icon or the like) on the screen of the image display apparatus. The user may also be notified by outputting a predetermined sound through a speaker or the like. The user may also be notified by causing a light emitting element provided in a different region to the region of the screen to emit light in a predetermined emission pattern.

The first target value Yt may be a fixed value determined in advance by the manufacturer, or a value that can be modified by the user. For example, a target value of a calibration of the brightness or the color of the screen (a calibration for bringing the measurement value of the light emitted from the screen closer to the target value) may be used as the first target value. The first target value may be determined in accordance with the pixel values of the measurement image data. When the measurement image data are not synthesized, the first target value may be determined in accordance with the pixel values of the input image data.

The threshold that is compared with the difference between the corrected measurement value and the first target value may be a fixed value determined in advance by the manufacturer, or a value that can be modified by the user. A brightness difference determined on the basis of a visual characteristic of a human, for example, may be used as the threshold compared with the difference between the corrected measurement value and the first target value. More specifically, a brightness difference at which a human can perceive a difference may be used as the threshold compared with the difference between the corrected measurement value and the first target value. The threshold compared with the difference between the corrected measurement value and the first target value may be determined in accordance with the pixel values of the measurement image data. When the measurement image data are not synthesized, the threshold compared with the difference between the corrected measurement value and the first target value may be determined in accordance with the pixel values of the input image data.

(Operation 1 of Image Display Apparatus)

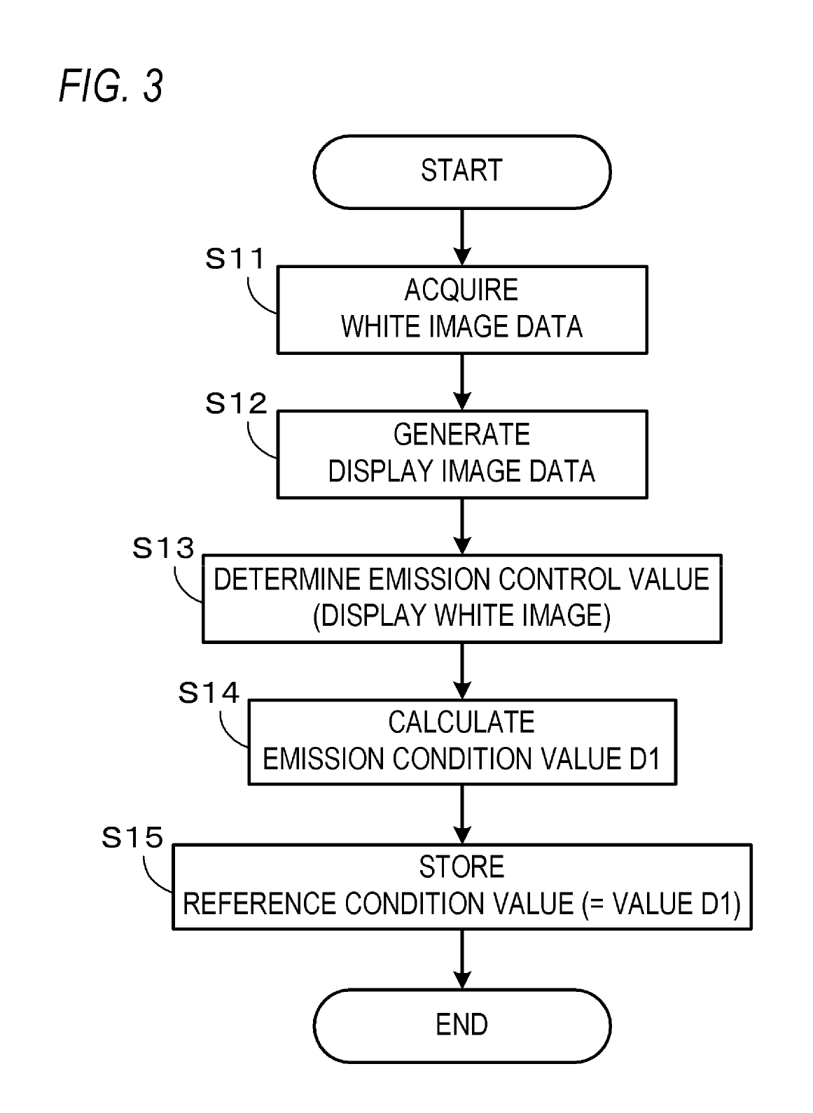

The reference condition value is determined by having the image display apparatus execute a flowchart shown in FIG. 3, for example.

Note that in this embodiment, an example of a case in which the reference condition is an emission condition in which the emission conditions of all of the light sources of the light emission unit 105 are equal will be described, but the reference condition is not limited thereto. For example, the reference condition may be an emission condition in which the emission conditions of a part of the light sources of the light emission unit 105 differ from the emission conditions of the remaining light sources of the light emission unit 105.

The method of determining the reference condition value is not limited to the method shown in the flowchart of FIG. 3, and instead, the reference condition value may be determined by a simulation, for example. The reference condition value may be, but is not limited to, a fixed value determined in advance by the manufacturer. The reference condition value may be determined when the user uses the image display apparatus for the first time, or immediately after a calibration is executed on the image display apparatus. Alternatively, the reference condition value may be determined at a desired timing of the user.

This operation will now be described using the flowchart in FIG. 3.

First, the image input unit 101 acquires the input image data, which are image data in which all of the pixel values are equal (S11). In this embodiment, white image data representing a white image which is a solid white image are acquired as the input image data. The white image data may be expressed as “image data in which all pixel values are white pixel values”. In this embodiment, it is assumed that the R value, the G value, and the B value are respectively 8-bit values. It is also assumed that the white pixel values (R value, G value, B value) are (255, 255, 255). The image input unit 101 outputs the white image data which is the input image data to the image processing unit 102 and the emission control unit 104. Note that gray image data representing a gray image which is a solid gray image may be used instead of the white image data. There are no particular limitations on the pixel values of the solid image.

Next, the image processing unit 102 generates the display image data by implementing image processing on the white image data (S12). More specifically, the image processing unit 102 generates the display image data by multiplying the R gain value, the G gain value, and the B gain value by the R value of the white image data, the G value of the white image data, and the B value of the white image data, respectively. The image processing unit 102 then outputs the generated display image data to the display unit 103. As a result, the transmittance of the display unit 103 is controlled to a transmittance based on the white image data.

Next, the emission control unit 104 determines an emission control value for each of the plurality of light sources provided in the light emission unit 105 (S13). As described above, the pixel values of the white image data are all equal to each other, and therefore values that are equal among the plurality of divided regions are obtained by the emission control unit 104 as the characteristic amounts of the image data to be displayed in the divided regions. The emission control unit 104 then determines the emission control value of each light source so as to eliminate surface unevenness in the light emitted from the light emission unit 105. The light sources at the ends of the screen have fewer adjacent light sources, and therefore an amount of light diffused from the adjacent light sources is smaller. Hence, by making the amount of light emitted from the light sources at the ends of the screen correspondingly larger than the amount of light emitted from the light sources in the center of the screen, surface unevenness in the light emitted from the light emission unit 105 is suppressed. In this embodiment, the light emission unit 105 includes N light sources, and numbers n (where n is an integer no smaller than 1 and no larger than N) of the N light sources are determined in advance. Here, the emission control value of a light source having the number n will be referred to as an “emission control value AAn”. The emission control unit 104 outputs the determined emission control values AA1 to AAN to the light emission unit 105. As a result, the respective light sources emit light in accordance with the emission control values. The light emitted from the light emission unit 105 is transmitted through the display unit 103, and as a result, a white image is displayed on the screen.

Next, the emission condition determination unit 107 calculates an emission condition value using the emission control value AAn determined in S13 and the diffusion profile (S14). Here, the coefficient of the light source having the number n, from among the coefficients expressed by the diffusion profile, will be referred to as a “coefficient Pn”. In S14, the emission condition determination unit 107 calculates an emission condition value D1 using Equation 1, shown below.

D1=AA1×P1+AA2×P2+ . . . +AAN×PN (Equation 1)

The emission condition determination unit 107 then outputs the calculated emission condition value D1 to the measurement value correction unit 108.

The measurement value correction unit 108 stores the emission condition value D1 calculated in S14 as the reference condition value (S15).

(Operation 2 of Image Display Apparatus)

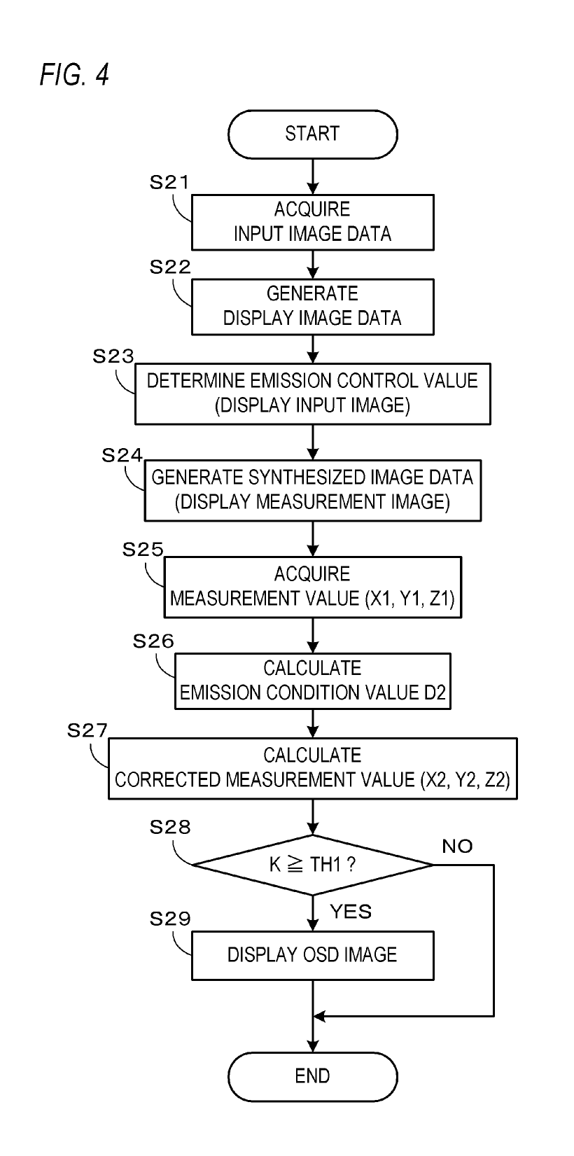

Next, processing for acquiring the corrected measurement value and comparing the corrected measurement value with the first target value will be described using a flowchart shown in FIG. 4.

The flowchart of FIG. 4 may be executed continuously after acquiring the reference condition value, or may be executed only within a period specified by the user. Alternatively, the flowchart of FIG. 4 may be executed continuously following the elapse of a predetermined time after a calibration is performed on the image display apparatus.

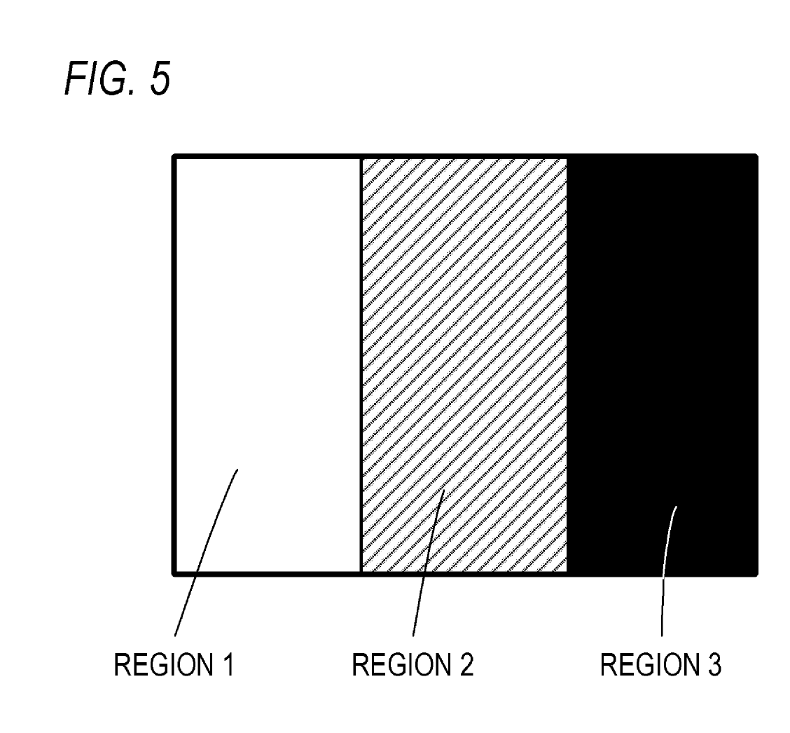

First, the image input unit 101 acquires the input image data (S21). There are no particular limitations on the input image data acquired in S21. The input image data acquired in S21 may be image data of a static image or image data of a moving image. When the input image data are image data of a moving image, the processing is performed on each frame. Here, an example of a case in which input image data representing an input image shown in FIG. 5 are acquired will be described. FIG. 5 shows an example of an input image. The input image shown in FIG. 5 has three regions 1 to 3. The regions 1 to 3 have mutually differing pixel values. The region 1 is a white region, and the pixel values (R value, G value, B value) of the region 1 are (255, 255, 255). The region 2 is a gray region, and the pixel values of the region 2 are (128, 128, 128). The region 3 is a black region, and the pixel values of the region 3 are (0, 0, 0). The image input unit 101 outputs the input image data to the image processing unit 102 and the emission control unit 104.

Next, the image processing unit 102 generates the display image data by implementing image processing on the input image data (S22). More specifically, the image processing unit 102 generates the display image data by multiplying the R gain value, the G gain value, and the B gain value by the R value of the input image data, the G value of the input image data, and the B value of the input image data, respectively. The image processing unit 102 then outputs the generated display image data to the display unit 103. As a result, the transmittance of the liquid crystal element in the region 1 of FIG. 5 is controlled to a value based on the pixel values (255, 255, 255). More specifically, the transmittance of the liquid crystal element in the region 1 is controlled to a value that corresponds to a value obtained by multiplying a gain value by the pixel values (255, 255, 255). The transmittance of the liquid crystal element in the region 2 is controlled to a value based on the pixel values (128, 128, 128), and the transmittance of the liquid crystal element in the region 3 is controlled to a value based on the pixel values (0, 0, 0).

Next, the emission control unit 104 determines an emission control value for each of the plurality of light sources provided in the light emission unit 105 (S23). In a case where a maximum value of the pixel values of the image data is acquired as the characteristic amount, “255” is acquired as the characteristic amount in relation to the divided regions included in the region 1. Further, “128” is acquired as the characteristic amount in relation to the divided regions included in the region 2, and “0” is acquired as the characteristic amount in relation to the divided regions included in the region 3. An emission control value is then determined for each light source in accordance with the characteristic amount acquired in relation to the divided region corresponding to the light source. The region 1 is bright (the brightness expressed by the characteristic amount is high), and therefore a large emission control value corresponding to the high emission brightness is acquired in relation to the light sources provided in the region 1 (the light sources provided in the divided regions included in the region 1). The region 3 is dark (the brightness expressed by the characteristic amount is low), and therefore a small emission control value corresponding to the low emission brightness is acquired in relation to the light sources provided in the region 3. An emission control value between the emission control value acquired in relation to the light sources provided in the region 1 and the emission control value acquired in relation to the light sources provided in the region 3 is acquired in relation to the light sources provided in the region 2. Here, the emission control value of the light source having the number n will be referred to as an “emission control value ABn”. The emission control unit 104 outputs the determined emission control values AB1 to ABN to the light emission unit 105. As a result, the light sources provided in the region 1 emit light at a high emission brightness, and the light sources provided in the region 3 emit light at a low emission brightness. The light sources provided in the region 2 emit light at an emission brightness between the emission brightness of the light sources provided in the region 1 and the emission brightness of the light sources provided in the region 3. The light emitted from the light emission unit 105 is transmitted through the display unit 103, and as a result, the input image is displayed on the screen. By controlling the emission brightness of the respective light sources individually in accordance with the input image data, a display image having a higher contrast than that of a case in which the emission brightness of the plurality of light sources are equal can be obtained.

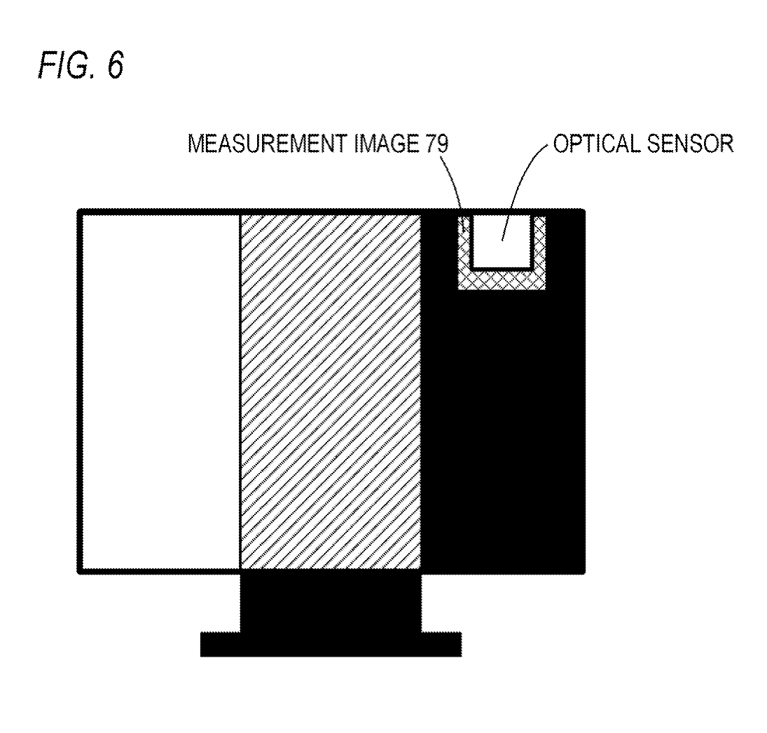

Next, the image processing unit 102 generates synthesized image data by synthesizing the measurement image data with the input image data (S24). After generating the synthesized image data, the image processing unit 102 generates the display image data by implementing image processing on (processing for multiplying a gain value by) the synthesized image data, and outputs the generated display image data to the display unit 103. As a result, the transmittance of the display unit 103 is modified from the transmittance based on the input image data to a transmittance based on the synthesized image data, whereby the display image is modified from the input image to a synthesized image. Here, an example of a case in which a synthesized image shown in FIG. 6 is displayed will be described. FIG. 6 shows an example of a synthesized image. On the synthesized image shown in FIG. 6, a measurement image 79 is disposed in the measurement region, i.e. the region in which the optical sensor used by the measurement value acquisition unit 106 is provided. The pixel values (R value, G value, B value) of the measurement image 79 are (255, 255, 255), for example.

Note that the processing of S24 may be performed without performing the processing of S22.

The measurement value acquisition unit 106 then acquires the measurement value of the measurement image displayed in the measurement region in S24 (S25). More specifically, the measurement value acquisition unit 106 acquires a measurement value of the screen light emitted from the measurement region when the synthesized image is displayed in S24. It is assumed here that (X1, Y1, Z1) are obtained as the measurement value (X value, Y value, Z value). The measurement value acquisition unit 106 outputs the acquired measurement value (X1, Y1, Z1) to the measurement value correction unit 108.

Next, the emission condition determination unit 107 calculates the emission condition value using the emission control value ABn determined in S23 and the diffusion profile (S26). In S26, the emission condition determination unit 107 calculates an emission condition value D2 using Equation 2, shown below.

D2=AB1×P1+AB2×P2+ . . . +ABN×PN (Equation 2)

The emission condition determination unit 107 then outputs the calculated emission condition value D2 to the measurement value correction unit 108.

Next, the measurement value correction unit 108 acquires a corrected measurement value (X2, Y2, Z2) by correcting the measurement value (X1, Y1, Z1) acquired in S25 on the basis of the reference condition value D1 and the emission condition value D2 acquired in S26 (S27). In S27, X2, which is the X value of the corrected measurement value, Y2, which is the Y value of the corrected measurement value, and Z2, which is the Z value of the corrected measurement value, are calculated respectively using Equation 3-1, Equation 3-2, and Equation 3-3, shown below.

X2=X1×D1/D2 (Equation 3-1)

Y2=Y1×D1/D2 (Equation 3-2)

Z2=Z1×D1/D2 (Equation 3-3)

The measurement value correction unit 108 then outputs the calculated corrected measurement value (X2, Y2, Z2) to the comparison unit 109.

In this embodiment, as shown in Equations 3-1 to 3-3, the corrected measurement value (X2, Y2, Z2) is calculated by multiplying D1/D2, which is an inverse of a variation rate of the emission condition value, by the measurement value (X1, Y1, Z1) acquired by the measurement value acquisition unit 106.

For example, when the emission condition value D2 decreases to half the reference condition value D1, the amount of light emitted onto the measurement region by the light emission unit 105 falls to half the amount of light emitted when the emission condition of the light emission unit 105 corresponds to the reference condition.

Accordingly, the measurement value (X1, Y1, Z1) of the screen light likewise falls to half the measurement value obtained when the emission condition of the light emission unit 105 corresponds to the reference condition.

In this embodiment, the corrected measurement value (X2, Y2, Z2)=(X1×2, Y1×2, Z1×2) is calculated by multiplying D1/D2=2, which is the inverse of the variation rate of the emission condition value, by the measurement value (X1, Y1, Z1) acquired by the measurement value acquisition unit 106. As a result, the current measurement value of the screen light when the emission condition of the light emission unit 105 corresponds to the reference condition can be obtained as the corrected measurement value (X2, Y2, Z2). In other words, the measurement value (X1, Y1, Z1) can be converted into the current measurement value of the screen light when the emission condition of the light emission unit 105 corresponds to the reference condition.

The comparison unit 109 determines whether or not the difference between the corrected measurement value (X2, Y2, Z2) calculated in S27 and the first target value equals or exceeds a threshold TH1 (S28). The first target value is a value set in advance by the user, for example.

In this embodiment, the comparison unit 109 compares Y2, i.e. the Y value of the corrected measurement value, with the first target value Yt (a target Y value; a target brightness value). More specifically, the comparison unit 109 calculates a brightness difference K using Equation 4, shown below.

K=|Y2−Yt| (Equation 4)

The comparison unit 109 then determines whether or not the brightness difference K equals or exceeds the threshold TH1.

When the brightness difference K equals or exceeds the threshold TH1, the processing is advanced to S29. When the brightness difference K is smaller than the threshold TH1, the current flow is terminated.

Note that the difference between the corrected measurement value and the first target value is not limited to an absolute value of a value obtained by subtracting one of the corrected measurement value and the first target value from the other, and instead, the difference between the corrected measurement value and the first target value may be a ratio between the corrected measurement value and the first target value.

A target value of the X value (a target X value) may be used as the first target value, and a determination may be made as to whether or not a difference between X2 and the target X value equals or exceeds a threshold. Further, a target value of the Z value (a target Z value) may be used as the first target value, and a determination may be made as to whether or not a difference between Z2 and the target Z value equals or exceeds a threshold. Three target values, namely the target X value, the target Y value, and the target Z value, may be used as the first target value, and a determination may be made as to whether or not an average value of the difference between X2 and the target X value, the difference between Y2 and the target Y value, and the difference between Z2 and the target Z value equals or exceeds a threshold.

When the brightness difference K is smaller than the threshold TH1, the processing may be returned to S21. When the processing is returned to S21 from S28, the processing may be returned to S21 either after waiting for a predetermined wait time or without waiting.

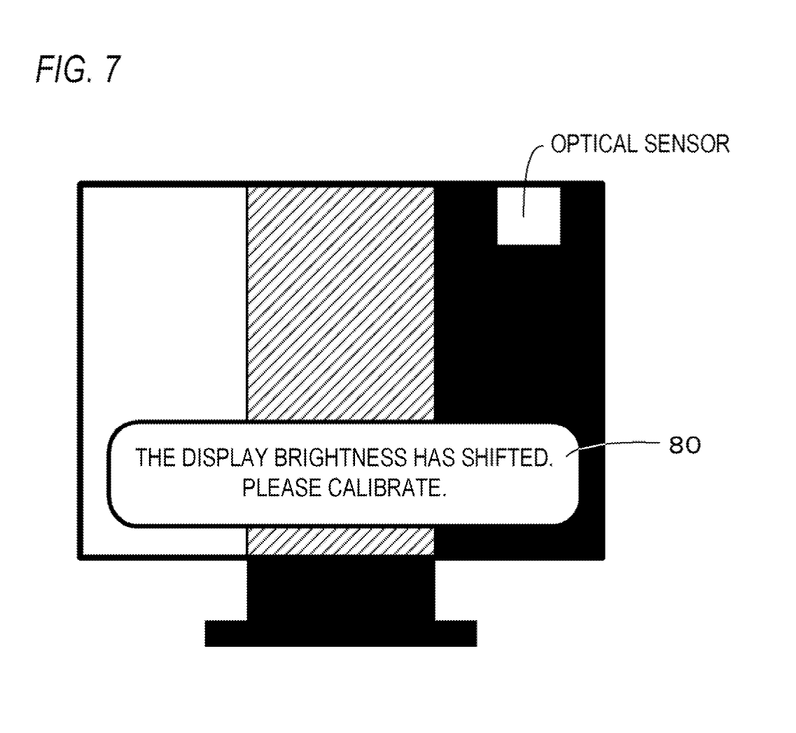

In S29, the comparison unit 109 generates the notification image data representing the OSD image on which the message indicating that the measurement value of the screen light differs from the target value is written, and outputs the notification image data to the display unit 103. As a result, the OSD image is displayed on the screen so that the user can be informed that the measurement value of the screen light differs from the target value. FIG. 7 shows an example of the OSD image. A reference numeral 80 denotes the OSD image. In the example of FIG. 7, a message stating that “The display brightness has shifted. Please calibrate” is written on the OSD image 80. Upon viewing the image, the user can determine that a calibration is necessary. The user can thus be prompted to execute the calibration at an appropriate timing.

According to this embodiment, as described above, variation in the emission brightness of the light source in response to variation in the input image data (for example, variation in the emission brightness of the light source caused by local dimming control) is not restricted. Moreover, according to this embodiment, the measurement value acquired by the measurement value acquisition unit is corrected so as to reduce variation in the measurement value of the screen light due to variation in the emission condition of the light emission unit from the reference condition. As a result, the measurement value of the optical sensor can be estimated independently of variation in the emission condition of the light emission unit due to variation in the input image data without causing the appearance of the display image to vary, even while local dimming control is underway.

Furthermore, according to this embodiment, when the difference between the corrected measurement value and the first target value equals or exceeds the threshold, the user is informed that the corrected measurement value differs from the first target value. As a result, the user can determine whether or not to execute the calibration with a high degree of precision.

Note that in this embodiment, the reference condition value D1 is calculated on the basis of the emission control value calculated in accordance with the characteristic amount of the white image data, but the emission condition used to calculate the reference condition value D1 is not limited thereto. For example, in a case where the image display apparatus includes a mode in which local dimming control is performed and a mode in which local dimming control is not performed, the reference condition value D1 may be calculated on the basis of an emission control value obtained in the mode in which local dimming control is not performed.

Further, in this embodiment, an example in which the emission condition of the light emission unit is determined on the basis of the emission control values was described, but the present invention is not limited thereto. For example, since light emission from the light emission unit is controlled on the basis of the input image data, the emission condition of the light emission unit may be determined on the basis of the input image data. Furthermore, the image display apparatus may include a measurement unit that measures the light emitted from the light emission unit. In this case, a measurement value from the measurement unit may be used as the emission condition of the light emission unit.

In this embodiment, an example of a case in which local dimming control is performed was described. The present invention is not limited to this example, however, and instead, light emission by the light emission unit may be controlled on the basis of the input image data. For example, the light emission unit may include a single light source that corresponds to the entire region of the screen, and light emission by the single light source may be controlled on the basis of the input image data.

In this embodiment, an example in which the user is notified when the difference between the corrected measurement value and the first target value equals or exceeds the threshold was described, but the present invention is not limited thereto.

For example, the image display apparatus may include a calibration unit that executes the calibration when the difference between the corrected measurement value and the first target value equals or exceeds the threshold. By determining whether or not to execute the calibration using the corrected measurement value, the determination as to whether or not to execute the calibration can be made with a high degree of precision. Further, by using the calibration unit described above, the calibration can be executed automatically at an appropriate timing. For example, the calibration unit calibrates the brightness and color of the screen using the corrected measurement value. Image processing parameters used during image processing implemented on the input image data are adjusted so that a gamma characteristic of the image display apparatus approaches a desired characteristic, for example. The calibration unit may also calibrate the emission brightness and emission color of the light source. In this case, the emission brightness and emission color of the light source are adjusted so as to approach target values.

Note that the calibration may be executed using either the corrected measurement value or the pre-correction measurement value.

The corrected measurement value is a value obtained by suppressing variation in the measurement value of the screen light due to variation in the emission condition of the light emission unit from the reference condition. By executing the calibration using the corrected measurement value, therefore, the calibration can be executed with a high degree of precision, and as a result, a highly precise calibration result can be obtained.

When the emission condition of the light emission unit is controlled to the reference condition during the calibration, the measurement value acquisition unit acquires a measurement value from which variation in the measurement value due to local dimming control is absent. By controlling the emission condition of the light emission unit to the reference condition during the calibration, therefore, a highly precise calibration result can be obtained even when the calibration is executed using the pre-correction measurement value.

Note that when the calibration unit provided in the image display apparatus is a calibration unit that executes the calibration using the corrected measurement value, the determination as to whether or not the difference between the corrected measurement value and the first target value equals or exceeds the threshold need not be performed. For example, the calibration may be executed at a timing specified by the user or a predetermined timing.

### Second Embodiment

An image display apparatus and a control method thereof according to a second embodiment of the present invention will be described below with reference to the drawings. In this embodiment, an example of a case in which the image display apparatus includes a measurement unit that measures the light emitted by the light emission unit will be described.

Configurations and processing that differ from the first embodiment will be described in detail below, while description of similar configurations and processing to the first embodiment will be omitted.

(Configuration of Image Display Apparatus)

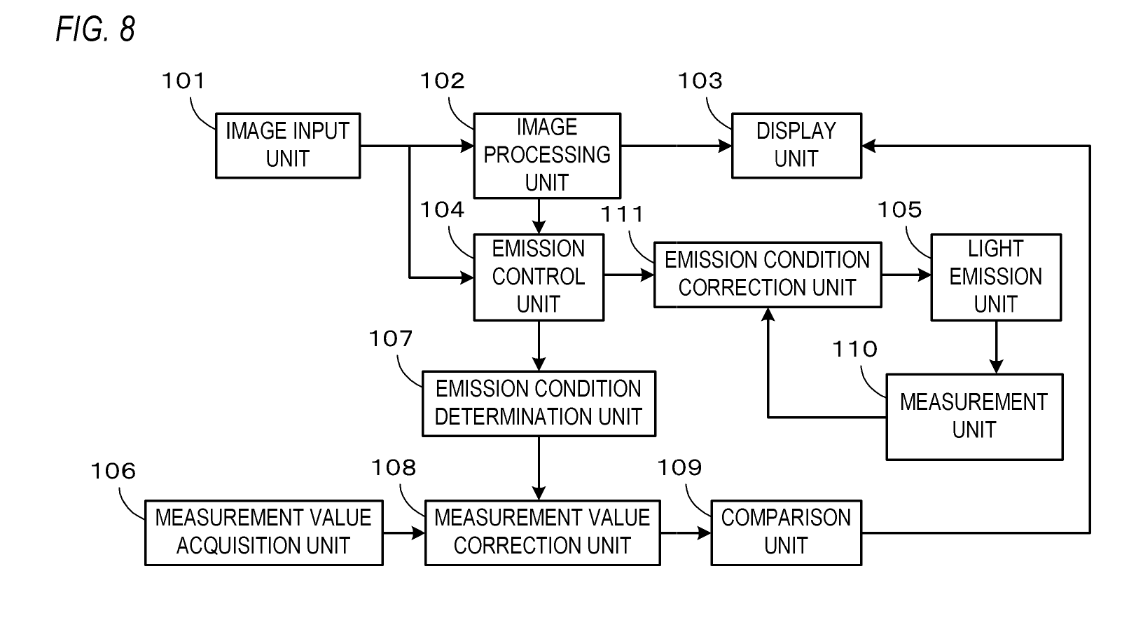

FIG. 8 is a block diagram showing an example of a functional configuration of the image display apparatus according to this embodiment. As shown in FIG. 8, the image display apparatus according to this embodiment includes the image input unit 101, the image processing unit 102, the display unit 103, the emission control unit 104, the light emission unit 105, a measurement unit 110, an emission condition correction unit 111, the measurement value acquisition unit 106, the emission condition determination unit 107, the measurement value correction unit 108, the comparison unit 109, and so on.

Note that of the function units shown in FIG. 8, identical function units to those of the first embodiment (FIG. 1) have been allocated identical reference numerals, and description thereof has been omitted.

In this embodiment, the emission control unit 104 performs PWM control on the light emitted by the light emission unit 105. In other words, in this embodiment, the emission control unit 104 controls (a length of) an emission period of the light emission unit 105. More specifically, the emission control unit 104 controls the pulse width of the pulse signal which is the drive signal applied to the light emission unit 105. In this embodiment, the light emitted by the light emission unit 105 during the emission period is not modified intentionally. More specifically, the pulse amplitude of the pulse signal which is the drive signal applied to the light emission unit 105 is not modified.

The measurement unit 110 measures an instantaneous value of the light emitted from the light emission unit 105 during the emission period (a period in which the light emission unit 105 emits light; a period in which a value of the pulse signal is “High”). An optical sensor (a brightness sensor, a chromaticity sensor, an image capturing apparatus, or the like), for example, can be used as the measurement unit 110. A measurement value of the measurement unit 110 is constituted by XYZ tri-stimulus values, for example.

The measurement unit 110 outputs the measurement value of the instantaneous value of the light emitted from the light emission unit 105 to the emission condition correction unit 111.

In a liquid crystal display apparatus or the like, the light emission unit 105 is also known as a “backlight”. Hereafter, therefore, the measurement value of the measurement unit 110 (the measurement value of the light emitted from the light emission unit 105) will be referred to as a “BL (Backlight) measurement value”. Further, the measurement value (the measurement value of the screen light) acquired by the measurement value acquisition unit 106 will be referred to as a “screen measurement value”.

Note that the BL measurement value may be a brightness value, a chromaticity value, RGB values, or the like rather than XYZ values.

The measurement unit 110 may include a single optical sensor or a plurality of optical sensors. When the measurement unit 110 includes a single optical sensor, a measurement value of the optical sensor may be acquired as the BL measurement value. When the measurement unit 110 includes a plurality of optical sensors, a plurality of measurement values obtained by the plurality of optical sensors may be acquired respectively as BL measurement values. A representative value of the plurality of measurement values acquired by the plurality of optical sensors may then be acquired as the BL measurement value.

There are no particular limitations on the layout of the optical sensors provided in the measurement unit 110. For example, when the measurement unit 110 includes a single optical sensor, the optical sensor may be disposed in the center of the region of the screen or at an end of the region of the screen. When the measurement unit 110 includes a plurality of optical sensors, the plurality of optical sensors may be disposed at regular or irregular intervals.

The emission condition correction unit 111 corrects the emission condition of the light emission unit 105 so as to reduce variation in the emission condition of the light emission unit 105 due to at least one of a deterioration condition of the light emission unit 105 and a peripheral environment (a temperature and so on) of the light emission unit 105 (second correction processing). The emission condition correction unit 111 corrects the emission condition of the light emission unit 105 on the basis of a difference between the current BL measurement value of the measurement unit 110 and a second target value of the measurement unit 110. In this embodiment, the emission control values input into the light emission unit 105 are corrected, and corrected emission control values are output to (set in) the light emission unit 105. As a result, the emission condition of the light emission unit 105 is corrected.

More specifically, the emission condition correction unit 111 determines a correction value to be used during the processing for correcting the emission control values on the basis of the difference between the current BL measurement value of the measurement unit 110 and the second target value. In this embodiment, a correction coefficient that is multiplied by the emission control value is determined as the correction value.

The emission condition correction unit 111 then corrects the emission condition of the light emission unit 105 using the determined correction value. In this embodiment, the emission condition correction unit 111 corrects the emission control values input into the light emission unit 105 by multiplying the correction value (the correction coefficient) by the emission control values output from the emission control unit 104. When the correction coefficient is larger than 1, the length of the emission period is increased, whereby the emission brightness of the light emission unit 105 is increased. When the correction coefficient is smaller than 1, the length of the emission period is reduced, whereby the emission brightness of the light emission unit 105 is reduced.

The correction value may be a correction addition value that is added to the emission control values.

Note that the emission condition value generated by the emission condition determination unit 107 is not dependent on the deterioration condition of the light emission unit 105 and the peripheral environment of the light emission unit 105. In this embodiment, therefore, the emission control values input into the emission condition determination unit 107 are not corrected.

(Operation 1 of Image Display Apparatus)

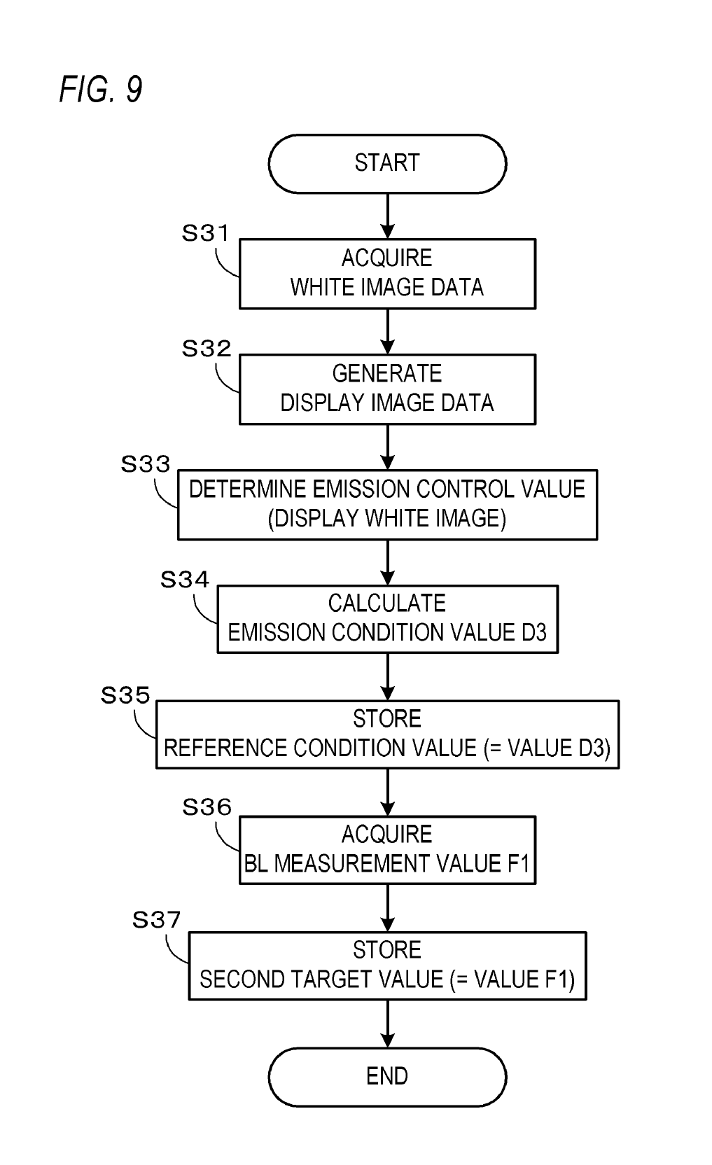

The second target value is determined by having the image display apparatus execute a flowchart shown in FIG. 9, for example. The flowchart of FIG. 9 is executed before the second correction processing. By executing the flowchart of FIG. 9, a past BL measurement value of the measurement unit 110 is acquired as the second target value.

Note that the method of determining the second target value is not limited to the method shown on the flowchart of FIG. 9. For example, the second target value may be determined by a simulation. The second target value may be, but is not limited to, a fixed value determined in advance by the manufacturer. The second target value may be determined when the user uses the image display apparatus for the first time, or at a desired timing of the user. Furthermore, the second target value may be determined as desired by the user.

This operation will now be described using the flowchart in FIG. 9.

First, the image input unit 101 acquires white image data as the input image data (S31). The image input unit 101 outputs the white image data which is the input image data to the image processing unit 102 and the emission control unit 104.

Next, the image processing unit 102 generates the display image data by implementing image processing on the white image data (S32). The image processing unit 102 then outputs the generated display image data to the display unit 103. As a result, the transmittance of the display unit 103 is controlled to a transmittance based on the white image data.

Next, the emission control unit 104 determines an emission control value for each of the plurality of light sources provided in the light emission unit 105 (S33). In this embodiment, the light emission unit 105 includes N light sources, and numbers n (where n is an integer no smaller than 1 and no larger than N) of the N light sources are determined in advance. Here, the emission control value of a light source having the number n will be referred to as an “emission control value BAn”. The emission control unit 104 outputs the determined emission control values BA1 to BAN to the light emission unit 105. As a result, the respective light sources emit light in accordance with the emission control values. The light emitted from the light emission unit 105 is transmitted through the display unit 103, and as a result, a white image is displayed on the screen.

Next, the emission condition determination unit 107 calculates an emission condition value using the emission control value BAn determined in S33 and the diffusion profile (S34). Here, the coefficient of the light source having the number n, from among the coefficients expressed by the diffusion profile, will be referred to as a “coefficient Pn”. In S34, the emission condition determination unit 107 calculates an emission condition value D3 using Equation 5, shown below.

D3=BA1×P1+BA2×P2+ . . . +BAN×PN (Equation 5)

The emission condition determination unit 107 then outputs the calculated emission condition value D3 to the measurement value correction unit 108.

The measurement value correction unit 108 stores the emission condition value D3 calculated in S34 as the reference condition value (S35).

Next, the measurement unit 110 acquires a BL measurement value F1 by measuring the instantaneous value of the light emitted from the light emission unit 105 (S36). The measurement unit 110 outputs the BL measurement value F1 to the emission condition correction unit 111.

The emission condition correction unit 111 stores the BL measurement value F1 acquired in S36 as the second target value (S37).

Note that the timing at which to determine the second target value is not limited to the timing described above. For example, the processing of S36 and S37 may be performed in parallel with the processing of S34 and S35. Further, the processing of S36 and S37 may be performed before the processing of S34 or before the processing of S35. Furthermore, the second target value may be determined by different processing to the processing for determining the reference condition value. The image data used to determine the second target value need not be white image data. For example, the image data used to determine the second target value may be gray image data.

(Operation 2 of Image Display Apparatus)

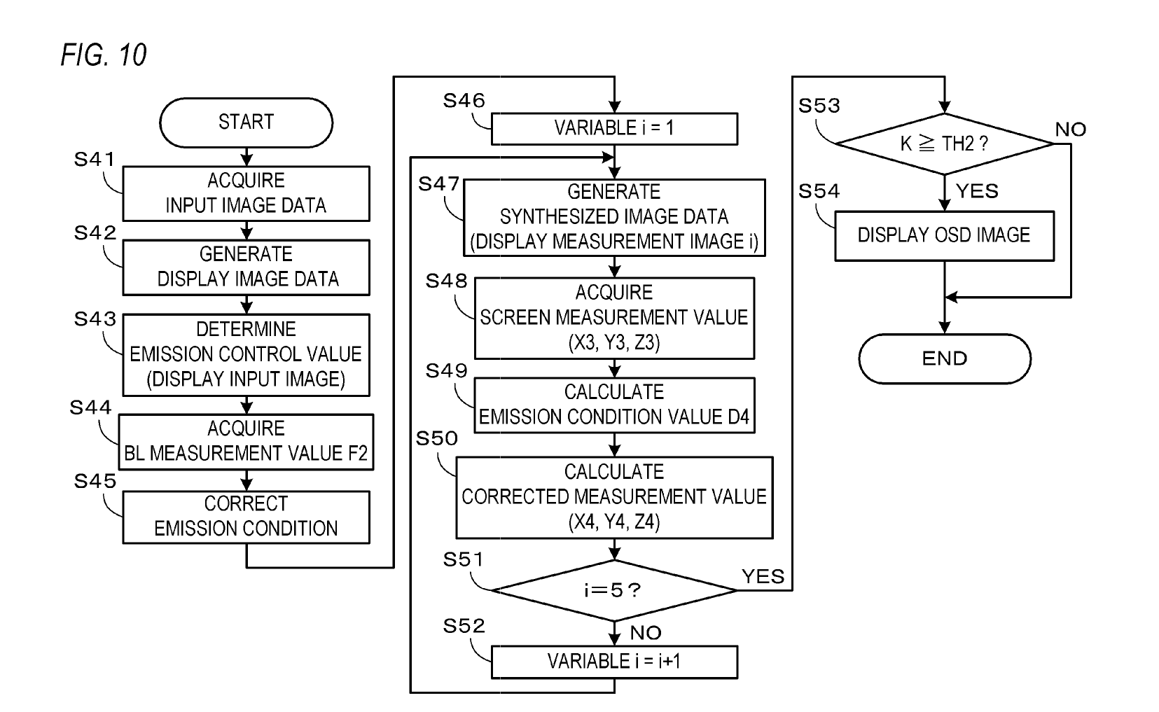

Next, processing for correcting the emission condition of the light emission unit 105 and processing for comparing the corrected measurement value with the first target value will be described using a flowchart shown in FIG. 10. The flowchart of FIG. 10 shows an example of a case in which variation in a gradation characteristic (the gamma characteristic) of the image display apparatus is detected. The gradation characteristic expresses a correspondence relationship between the pixel value and the value of the screen light, for example.

The flowchart shown in FIG. 10 may be executed continuously after determining the reference condition value and the second target value, or may be executed only within a period specified by the user. Alternatively, the flowchart of FIG. 10 may be executed continuously following the elapse of a predetermined time after the calibration is performed on the image display apparatus.

First, the image input unit 101 acquires the input image data (S41). There are no particular limitations on the input image data acquired in S41. The input image data acquired in S41 may be image data of a static image or image data of a moving image. When the input image data are image data of a moving image, the processing is performed on each frame. The image input unit 101 outputs the input image data to the image processing unit 102 and the emission control unit 104.

Next, the image processing unit 102 generates the display image data by implementing image processing on the input image data (S42). The image processing unit 102 then outputs the generated display image data to the display unit 103. As a result, the transmittance of the display unit 103 is controlled to a transmittance based on the input image data.

Next, the emission control unit 104 determines an emission control value for each of the plurality of light sources provided in the light emission unit 105 (S43). Here, the emission control value of the light source having the number n will be referred to as an “emission control value BBn”. The emission control unit 104 outputs the determined emission control values BB1 to BBN to the light emission unit 105. As a result, the respective light sources emit light in accordance with the emission control values. The light emitted from the light emission unit 105 is transmitted through the display unit 103, and as a result, the input image is displayed on the screen. The emission control unit 104 also outputs the determined emission control values BB1 to BBN to the emission condition correction unit 111.

Next, the measurement unit 110 acquires a BL measurement value F2 by measuring the instantaneous value of the light emitted from the light emission unit 105 (S44). The measurement unit 110 outputs the BL measurement value F2 to the emission condition correction unit 111. When the deterioration condition of the light emission unit 105, the peripheral environment of the light emission unit 105, and so on are unchanged from the time at which the BL measurement value F1 was acquired, an identical value to the BL measurement value F1 is acquired as the BL measurement value F2. When the deterioration condition of the light emission unit 105, the peripheral environment of the light emission unit 105, and so on have changed from the time at which the BL measurement value F1 was acquired, a different value to the BL measurement value F1 is acquired as the BL measurement value F2.

The emission condition correction unit 111 corrects the emission condition of the light emission unit 105 on the basis of a difference between the past BL measurement value F1 (the second target value) and the current BL measurement value F2 (S45).

The processing of S45 will now be described in detail.

First, the emission condition correction unit 111 calculates a correction coefficient C using Equation 6, shown below. More specifically, the correction coefficient C is calculated by dividing the BL measurement value F1 by the BL measurement value F2.

Correction coefficient C=BL measurement value F1/BL measurement value F2 (Equation 6)

Next, the emission condition correction unit 111 corrects the emission control value BBn of each light source, determined in S43, by multiplying the correction coefficient C by the emission control value BBn of each light source.

The emission condition correction unit 111 then outputs the corrected emission control values of the respective light sources to the light emission unit 105. As a result, the emission condition of the light emission unit 105 is corrected. More specifically, the emission conditions of the respective light sources are corrected from emission conditions corresponding to the emission control values determined in S43 to emission conditions corresponding to the corrected emission control values.

For example, when the current instantaneous value of the light emitted from the light emission unit 105 has decreased from when the BL measurement value F1 was determined, a smaller value than the BL measurement value F1 is obtained as the BL measurement value F2. Accordingly, a value larger than 1 is calculated as the correction coefficient C. In a case where the correction coefficient is larger than 1, the length of the emission period is increased, leading to an increase in the emission brightness of the light emission unit 105, when the correction coefficient C is multiplied by the emission control values determined in S43. As a result, a reduction in the instantaneous value of the light emitted from the light emission unit 105 can be suppressed.

Note that the difference between the BL measurement value F1 and the BL measurement value F2 is not limited to a ratio between the BL measurement value F1 and the BL measurement value F2, and instead, the difference between the BL measurement value F1 and the BL measurement value F2 may be a value obtained by subtracting one of the BL measurement value F1 and the BL measurement value F2 from the other.

Next, the image processing unit 102 sets “1” as a variable i denoting a number of the measurement image (S46).

The image processing unit 102 then generates synthesized image data by synthesizing measurement image data having the number i with the input image data (S47). After generating the synthesized image data, the image processing unit 102 generates the display image data by implementing image processing on the synthesized image data, and outputs the generated display image data to the display unit 103. As a result, the transmittance of the display unit 103 is modified from the transmittance based on the input image data to a transmittance based on the synthesized image data, whereby the display image is modified from the input image to a synthesized image.

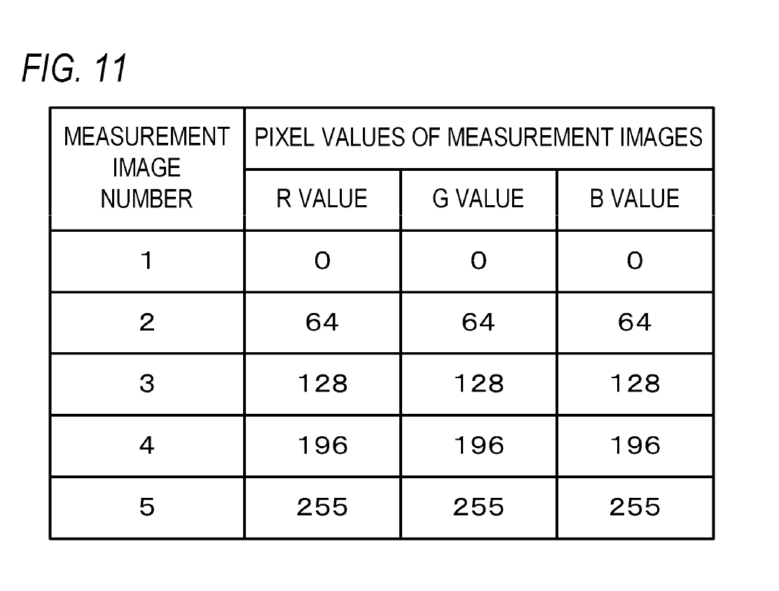

In this embodiment, as shown in FIG. 11, a plurality of sets of measurement image data (respective pixel values of a plurality of measurement images) are set. In the example of FIG. 11, five measurement images associated with numbers 1 to 5 are set. The measurement image having the number i will be referred to hereafter as a “measurement image i”. In FIG. 11, the pixel values (R value, G value, B value) of a measurement image 1 are (0, 0, 0), the pixel values of a measurement image 2 are (64, 64, 64), and the pixel values of a measurement image 3 are (128, 128, 128). The pixel values of a measurement image 4 are (192, 192, 192), and the pixel values of a measurement image 5 are (255, 255, 255). When the variable i=1, the measurement image 1 is displayed, when the variable i=2, the measurement image 2 is displayed, and when the variable i=3, the measurement image 3 is displayed. When the variable i=4, the measurement image 4 is displayed, and when the variable i=5, the measurement image 5 is displayed. The measurement image 1 is a black image, the measurement images 2 to 4 are gray images, and the measurement image 5 is a white image.

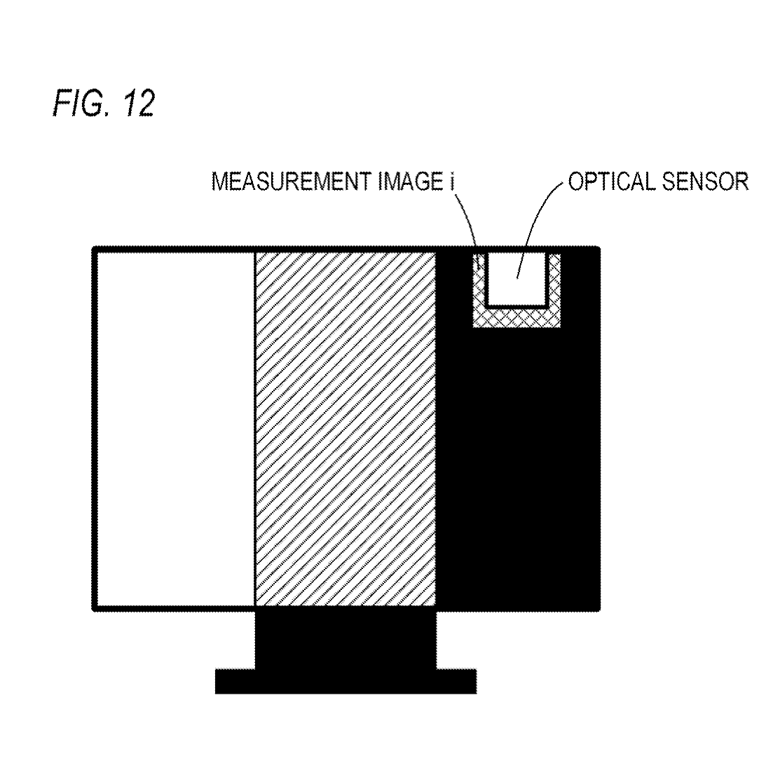

FIG. 12 shows an example of a synthesized image. On the synthesized image shown in FIG. 12, the measurement image i is disposed in the measurement region, i.e. the region in which the optical sensor used by the measurement value acquisition unit 106 is provided.

Note that the number of measurement images may be larger or smaller than five.

Next, the measurement value acquisition unit 106 acquires the measurement value (a screen measurement value) of the measurement image di splayed in the measurement region in S47 (S48). It is assumed here that (X3, Y3, Z3) are obtained as the screen measurement value (X value, Y value, Z value). The measurement value acquisition unit 106 outputs the acquired screen measurement value (X3, Y3, Z3) to the measurement value correction unit 108.

Next, the emission condition determination unit 107 calculates the emission condition value using the emission control value BBn determined in S43 and the diffusion profile (S49). In S49, the emission condition determination unit 107 calculates an emission condition value D4 using Equation 7, shown below.

D4=BB1×P1+BB2×P2++BBN×PN (Equation 7)

The emission condition determination unit 107 then outputs the calculated emission condition value D4 to the measurement value correction unit 108.

Next, the measurement value correction unit 108 acquires a corrected measurement value (X4, Y4, Z4) by correcting the screen measurement value (X3, Y3, Z3) acquired in S48 on the basis of the reference condition value D3 and the emission condition value D4 acquired in S49 (S50). In S50, X4, which is the X value of the corrected measurement value, Y4, which is the Y value of the corrected measurement value, and Z4, which is the Z value of the corrected measurement value, are calculated respectively using Equation 8-1, Equation 8-2, and Equation 8-3, shown below.

X4=X3×D3/D4 (Equation 8-1)

Y4=Y3×D3/D4 (Equation 8-2)

Z4=Z3×D3/D4 (Equation 8-3)

The image processing unit 102 then determines whether or not the variable i is at 5 (S51).

When the variable i is smaller than 5, the image processing unit 102 determines that a measurement image that has not yet been measured exists. Accordingly, the processing is advanced to S52. In S52, the image processing unit 102 increments the variable i by 1. The processing is then returned to S47, whereupon the processing of S47 to S52 is repeated until the variable i reaches 5.

When the variable i is at 5, the image processing unit 102 determines that measurement has been performed on all of the measurement images. Accordingly, the processing is advanced to S53.

In S53, the comparison unit 109 determines, in relation to each measurement image, whether or not the difference between the corrected measurement value (X4, Y4, Z4) calculated in S50 and the first target value equals or exceeds a threshold TH2. In this embodiment, a plurality of first target values corresponding respectively to the plurality of measurement images are set. The threshold TH2 may be, but does not have to be, a common value among the plurality of measurement images. A plurality of thresholds TH2 corresponding respectively to the plurality of measurement images may be set.

Note that the first target values may be fixed values determined in advance by the manufacturer, or values that can be modified by the user. The first target values can be determined using a similar method to the first embodiment. The first target values may be determined on the basis of a target gradation characteristic and the pixel value of the measurement image. More specifically, a screen light value corresponding to the pixel value of the measurement image i, from among screen light values that satisfy the target gradation characteristic, may be determined as the first target value corresponding to the measurement image i.

The threshold TH2 may be a fixed value determined in advance by the manufacturer or a value that can be modified by the user. The threshold TH2 can be determined using a similar method to the method used to determine the threshold TH1 in the first embodiment.

Hereafter, the Y value of the corrected measurement value of the measurement image i will be referred to as “Y4_i”, and the first target value which is the target value of Y4_i will be referred to as “Yt_i”.

In this embodiment, the comparison unit 109 compares the Y value Y4_i with the first target value Yt_i with respect to the measurement image having the number i. More specifically, the comparison unit 109 calculates a brightness difference Ki using Equation 9, shown below. The brightness difference Ki is the brightness difference K calculated in relation to the measurement image i.

K=|Y4_{—}i−Yt_{—}i| (Equation 9)

The comparison unit 109 then determines whether or not the brightness difference Ki equals or exceeds the threshold TH2 with respect to the measurement image i.

The comparison unit 109 calculates the brightness difference K and compares the brightness difference K with the threshold TH2 in relation to all of the measurement images.

When a measurement image in which the brightness difference K equals or exceeds the threshold TH2 exists, the processing is advanced to S54. When the brightness difference K is smaller than the threshold TH2 with respect to all of the measurement images, the current flow is terminated.

In S54, the comparison unit 109 generates the notification image data representing the OSD image on which the message indicating that the measurement value of the screen light differs from the target value is written, and outputs the notification image data to the display unit 103. As a result, the OSD image is displayed on the screen so that the user can be informed that the measurement value of the screen light differs from the target value.

Note that the timing at which to correct the emission condition of the light emission unit 105 is not limited to the timing described above, and the processing of S44 and S45 may be performed before the processing of S48 or in parallel with the processing of S46 and S47.

According to this embodiment, as described above, variation in the emission brightness of the light source in response to variation in the input image data (for example, variation in the emission brightness of the light source caused by local dimming control) is not restricted. Moreover, according to this embodiment, the screen measurement value acquired by the measurement value acquisition unit is corrected so as to reduce variation in the screen measurement value due to variation in the emission condition of the light emission unit from the reference condition. As a result, the measurement value of the optical sensor can be estimated independently of variation in the emission condition of the light emission unit due to variation in the input image data without causing the appearance of the display image to vary, even while local dimming control is underway.

Further, according to this embodiment, when the difference between the corrected screen measurement value and the first target value equals or exceeds the threshold, the user is informed that the corrected screen measurement value differs from the first target value. As a result, the user can determine whether or not to execute the calibration with a high degree of precision.

Moreover, according to this embodiment, the emission condition of the light emission unit is corrected on the basis of the difference between the current BL measurement value of the measurement unit and the second target value. It is therefore possible to obtain a display image in which variation in the emission condition of the light emission unit due to at least one of the deterioration condition of the light emission unit and the peripheral environment of the light emission unit is reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-098491, filed on May 12, 2014, and Japanese Patent Application No. 2015-044408, filed on Mar. 6, 2015, which are hereby incorporated by reference herein in their entirety.

What is claimed is:

1. An image display apparatus comprising:
a light emitting unit;
a display unit configured to display an image on a screen by modulating light emitted from the light emitting unit;
a control unit configured to control light emission by the light emitting unit on the basis of input image data;
an acquisition unit configured to acquire a measurement value of light emitted from the screen; and
a first correcting unit configured to correct a current measurement value acquired by the acquisition unit on the basis of a reference condition, which is a reference emission condition of the light emitting unit, and a current emission condition of the light emitting unit.

2. The image display apparatus according to claim 1, further comprising a notifying unit configured to notify a user that a measurement value that has been corrected by the first correcting unit differs from a first target value when a difference between the measurement value that has been corrected by the first correcting unit and the first target value equals or exceeds a threshold.

3. The image display apparatus according to claim 1, further comprising a calibration unit configured to execute a calibration on at least one of a brightness and a color of the screen when a difference between a measurement value that has been corrected by the first correcting unit and a first target value equals or exceeds a threshold.

4. The image display apparatus according to claim 3, wherein the calibration unit executes the calibration using the measurement value that has been corrected by the first correcting unit.

5. The image display apparatus according to claim 3, wherein a measurement value prior to correction by the first correcting unit is used in the calibration, and
the control unit controls the emission condition of the light emitting unit to the reference condition when the calibration is executed.

6. The image display apparatus according to claim 2, wherein the first target value is a target value of a calibration executed to bring the measurement value of the light emitted from the screen closer to a target value.

7. The image display apparatus according to claim 1, further comprising a calibration unit configured to execute a calibration on at least one of a brightness and a color of the screen using a measurement value that has been corrected by the first correcting unit.

8. The image display apparatus according to claim 1, wherein
the light emitting unit includes a plurality of light sources that can be subjected to light emission control individually,
the control unit controls light emission by the respective light sources on the basis of image data to be displayed in regions of the screen corresponding respectively to the plurality of light sources,
the acquisition unit acquires a measurement value of light emitted from a measurement region which is a partial region of the screen, and
the emission condition of the light emitting unit is an emission condition of the light emitting unit in the measurement region.

9. The image display apparatus according to claim 1, wherein the reference condition is an emission condition corresponding to image data in which all pixel values are equal.

10. The image display apparatus according to claim 1, wherein the emission condition of the light emitting unit includes at least one of an emission brightness and an emission color of the light emitting unit.

11. The image display apparatus according to claim 1, wherein
the light emitting unit emits light in accordance with a set emission control value,
the control unit controls the emission control value set in the light emitting unit, and
the image display apparatus further comprises a determining unit configured to determine the emission condition of the light emitting unit on the basis of the emission control value set in the light emitting unit.

12. The image display apparatus according to claim 1, further comprising a determining unit configured to determine the emission condition of the light emitting unit on the basis of the input image data.

13. The image display apparatus according to claim 1, further comprising a measuring unit configured to measure the light emitted from the light emitting unit,
wherein a measurement value of the measuring unit is used as the emission condition of the light emitting unit.

14. The image display apparatus according to claim 1, wherein
the control unit controls an emission period of the light emitting unit, and
the image display apparatus further comprises:
a measuring unit configured to measure an instantaneous value of light emitted from the light emitting unit during an emission period; and
a second correcting unit configured to correct the emission condition of the light emitting unit on the basis of a difference between a current measurement value of the measuring unit and a second target value so as to reduce variation in the emission condition of the light emitting unit due to at least one of a deterioration condition of the light emitting unit and a peripheral environment of the light emitting unit.

15. The image display apparatus according to claim 14, wherein the second target value is a past measurement value of the measuring unit.

16. A control method for an image display apparatus having a light emitting unit and a display unit configured to display an image on a screen by modulating light emitted from the light emitting unit,
the control method comprising:
a control step of controlling light emission by the light emitting unit on the basis of input image data;
an acquisition step of acquiring a measurement value of light emitted from the screen; and
a first correction step of correcting a current measurement value acquired in the acquisition step on the basis of a reference condition, which is a reference emission condition of the light emitting unit, and a current emission condition of the light emitting unit.

17. A non-transitory computer readable medium that stores a program, wherein the program causes a computer to execute the method according to claim 16.
